(19) United States
(12) Patent Application Publication
(10) Pub. No.: US 2015/0022811 A1
(43) Pub. Date: Jan. 22, 2015

(54) COMPACT HYPERSPECTRAL IMAGING SYSTEM

(71) Applicant: Corning Incorporated, Corning, NY (US)

(72) Inventors: James Dixon Cornell, Rochester, NY (US); Stephen Edward Herbert, Manchester, NH (US); Jeffry John Santman, Westmoreland, NH (US); Philip Madrid Uy, Antrim, NH (US); Kenneth Smith Woodard, New Boston, NH (US)

(21) Appl. No.: 14/310,166

(22) Filed: Jun. 20, 2014

Related U.S. Application Data
(60) Provisional application No. 61/856,319, filed on Jul. 19, 2013.

(51) Int. Cl. G01J 3/02; G01J 3/28

(52) U.S. Cl. CPC G01J 3/0256; G01J 3/2823; G01J 3/0291; G01J 2003/2826
USPC 356/326; 356/300

(57) ABSTRACT

A lightweight, compact hyperspectral imaging system includes a fore-optics module and a wavelength-dispersing module. The imaging system may also include a detector, supporting electronics and a battery module. The fore-optics module may include a telescope with three or more mirrors, where the mirrors include a silver coating that provides high reflectivity over wavelengths in the visible and shortwave infrared portions of the spectrum. The modules of the imaging system may be incorporated in a housing having a longest linear dimension of 16 inches or less. The housing may be cylindrical in shape and have a length of 14 inches or less inches and a diameter of 8 inches or less.

This application claims the benefit of priority under 35 U.S.C. §119 of U.S. Provisional Application Ser. No. 61/856319 filed on Jul. 19, 2013 the content of which is relied upon and incorporated herein by reference in its entirety.

### FIELD OF THE DISCLOSURE

This disclosure relates to hyperspectral imaging. More particular, this disclosure relates to a compact and lightweight hyperspectral imager. More particularly, this disclosure relates to a hyperspectral imager that includes fore-optics interfaced with an Offner spectrometer, where the fore-optics include a telescope.

### BACKGROUND OF THE DISCLOSURE

Hyperspectral imaging is emerging as the leading technique for remote imaging and detection. Applications of hyperspectral imagining include airborne reconnaissance in military and aerospace applications, environmental monitoring, agricultural monitoring, geological surveying, mineral exploration, and medical diagnosis.

Hyperspectral imaging systems measure the spectral features of objects in real-world scenes. Typically, the scene is broken into a grid and a spectrum is measured for each element of the grid. The spectrum typically consists of light reflected and/or scattered from objects in the scene. During imaging, the scene of interest is divided into slices and each slice is imaged separately. The image of the scene is acquired by sequentially sampling the slices.

Hyperspectral image acquisition involves acquiring spectra for each slice of the scene over a wide range of wavelengths. The wide wavelength range is desirable because different objects in a scene reflect or scatter light at multiple wavelengths. By acquiring spectral data over a wide wavelength range, it becomes possible to identify and discriminate between different objects in a scene with greater precision. To improve the quality of the hyperspectral image, it is necessary to insure high spatial resolution and high wavelength resolution. High wavelength resolution is achieved in hyperspectral imaging by dividing the detected wavelength range into a series of narrow contiguous wavelength bands and detecting each band separately. The wavelength bands in hyperspectral imaging may be 10 nm or less. Acquiring spectra over the series of narrow wavelength bands provides more detail about the objects in the scene and allows for accurate fingerprinting of individual objects. The ability to narrow the wavelength range of detected spectral bands has been made possible by recent advances in detector design, image processing and data storage.

A typical hyperspectral imaging system includes fore-optics, a spectrometer with an entrance slit, a focal plane array detector, and supporting electronics. The fore-optics receive spectral input from a real-world scene and focus it on the spectrometer's entrance slit. The spectrometer resolves the spectral input into wavelength bands and directs the resolved input to the focal plane array detector. The focal plane array detector quantifies the spectral input of each wavelength band.

The emerging use of Hyperspectral Imaging (HSI) system in the Unmanned Aerial Vehicle (UAV) arena has been increasing. Weight and volume are severe constraints for these small air vehicles and other HSI applications requiring portability. Weight and volume are particularly challenging in applications requiring collection of image data over broader spectral ranges. Current hyperspectral imaging systems designed to operate over the visible and SWIR spectrum, for example, are too large and heavy for use in UAV and other applications that impose space and weight limits.

There remains a need for a hyperspectral imaging system that is lightweight, compact, and capable of operating over a wide range of wavelengths.

### SUMMARY

The present disclosure provides a compact hyperspectral imaging system suitable for weight- or space-constrained applications. The hyperspectral imaging system includes a fore-optics module and a wavelength-dispersing module. The hyperspectral imaging system may also include a detector and supporting electronics. The fore-optics module and wavelength-dispersing module are operatively coupled along a common optical path. The wavelength-dispersing module and detector are operatively coupled along a common optical path. The fore-optics module acquires image data from a scene and directs it to the wavelength-dispersing module, which resolves the image data according to wavelength and directs it to the detector to sense, quantify, and/or record it.

The fore-optics module may include a telescope. The telescope may be telecentric and may include three or more mirrors. The mirrors may be coated with silver to achieve high reflectivity in the visible and shortwave infrared portions of the spectrum. The fore-optics module may be forward looking or downward looking

The wavelength-dispersing element may include a spectrometer. The spectrometer may be an Offner spectrometer.

The detector may be a camera, or a photodiode, or a focal plane array, a CMOS device, or a wavelength-sensitive sensor.

The fore-optics module, wavelength-dispersing module, and detector may be integrated in a compact housing. The size and shape of the housing may be defined by a plurality of linear dimensions. The linear dimensions may be along orthogonal directions. The longest of the linear dimensions may be 16 inches or less. The housing may have a cylindrical shape with a length and a diameter. The length may be 14 inches or less and the diameter may be 10 inches or less.

The hyperspectral imaging system may include a fiber-optics module, wavelength-dispersing module, and detector integrated in a housing, where the system may weigh 5 kg or less and where the combined weight of the fiber-optics module and wavelength-dispersing module may be 4 kg or less.

The scope of the present disclosure includes:

A hyperspectral imaging system comprising:

a housing, said housing containing a fore-optics module, a wavelength-dispersing module, and a detector, said housing having a size defined by one or more linear dimensions, the longest of said linear dimension being 16 inches or less.

The scope of the present disclosure includes:

A method of acquiring an image comprising: providing a hyperspectral imaging system, said hyper spectral imaging system having a size defined by one or more linear dimensions, the longest of said linear dimensions being 12 inches or less;

supporting portable hyperspectral imaging system, said supporting occurring solely by hand; and

acquiring an image with said hand-supported hyperspectral imaging system.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present disclosure, and together with the description serve to explain principles and operation of methods, products, and compositions embraced by the present disclosure.

### BRIEF DESCRIPTION OF THE DRAWINGS

FIG. 1 depicts a portion of a hyperspectral imaging system.

FIG. 2 depicts a forward-looking fore-optics module.

FIG. 3 depicts a downward-looking fore-optics module.

FIG. 4 depicts a hyperspectral imaging system with a fore-optics module, a spectrometer module, and a visible-short wavelength infrared camera in a cylindrical housing.

FIG. 5 shows two views of a hyperspectral imaging system that includes a forward-looking fore-optics module and a spectrometer module.

FIG. 6 shows a hyperspectral imaging system with a housing that includes a downward-looking fore-optics module, a spectrometer module, and a detector.

FIG. 7 is an exploded view of FIG. 6.

### DETAILED DESCRIPTION

The present disclosure provides a compact hyperspectral imaging system suitable for weight- or space-constrained applications. The hyperspectral imaging system includes a fore-optics module and a wavelength-dispersing module. The hyperspectral imaging system may also include a detector and supporting electronics. The fore-optics module may include a telescope. The wavelength-dispersing module may be a spectrometer. The detector may be a sensor, camera, focal plane array or other device capable of detecting electromagnetic signals in the visible and near-infrared (NIR or SWIR) portions of the spectrum. The supporting electronics may aid in positioning the fore-optics, operating the spectrometer, or operating the detector. The supporting electronics may include memory to store image data or imaging software, and microprocessors to run imaging software.

The fore-optics module and wavelength-dispersing module may be operatively coupled along a common optical path. The wavelength-dispersing module and detector may be operatively coupled along a common optical path. The fore-optics module acquires image data from a scene and directs it to the wavelength-dispersing module, which resolves the image data according to wavelength and directs it to the detector to sense, quantify, and/or record the image data.

The hyperspectral imager gathers image data in the form of electromagnetic signals from real world scenes and provides sufficient resolution to discriminate between objects in the scene on the basis of electromagnetic signal. The fore-optics module gathers electromagnetic signals reflected by, radiated by, emitted by and/or otherwise emanating from objects in the scene and focuses it on the entrance slit of the wavelength-dispersing module. The fore-optics module may be telecentric. The fore-optics module may include a telescope. The optics of the telescope may include telecentric. The telescope may include three or more mirrors, or four or more mirrors that act to fold the optical path to insure adequate path length for focusing and collimation of the electromagnetic signals while maintaining a compact form factor. The mirror may be coated with a silver coating. Exemplary mirrors coated with silver exhibit the following average reflectivity over wavelengths ranging from 400 nm-2500 nm:

| Wavelength | Average |
|---|---|
| (nm) | Reflectivity |
| 400-425 | >87% |
| 426-450 | >93.5% |
| 451-700 | >98% |
| 701-2500 | >98% |

The high reflectivity throughout the indicated wavelength range contributes to high overall system efficiency over a wide range of wavelengths.

The wavelength-dispersing module receives electromagnetic image data from the fore-optics and separates or disperses it according to wavelength. The wavelength-dispersing module may include optics such as diffraction gratings, prisms, lenses, and mirrors. The wavelength-dispersing module may be a spectrometer. The spectrometer may be an Offner spectrometer. An Offner spectrometer is a particularly compact spectrometer that enables miniaturization of the hyperspectral imaging system. An example of an Offner spectrometer is described in U.S. Pat. No. 7,697,137, the disclosure of which is hereby incorporated in its entirety herein.

The wavelength-dispersing module may direct light to the detection element. The detection element may detect the wavelength, intensity, polarization or other characteristic of the light dispersed by the wavelength-dispersing element. The detection element may be a photodetector, a CCD device, a diode array, a focal plane array, a CMOS device, or other type of image detector known in the art for sensing electromagnetic radiation reflected over the wavelength range associated with physical objects in real-world scenes.

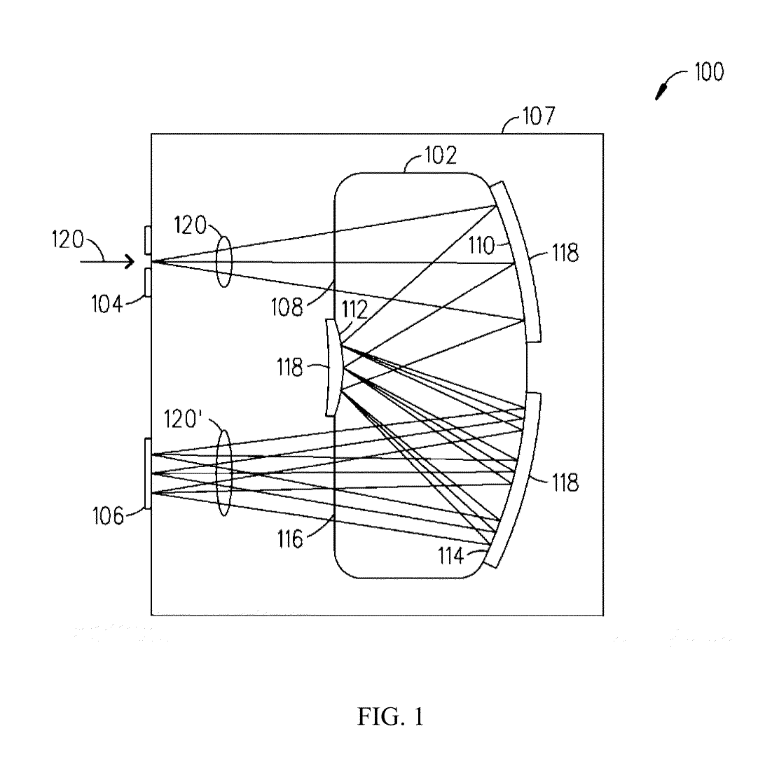

A portion of an illustrative hyperspectral imaging system is depicted in FIG. 1. Portion 100 includes an Offner spectrometer 102 within chamber 107. Hyperspectral camera 100 includes a slit 104 and a detector 106 attached to chamber 107. In the configuration shown, the Offner spectrometer 102 is a one-one optical relay made from a single piece of transmissive material 101 including an entrance surface 108, a first mirror 110 (formed when a reflective coating 118 is applied as shown to the surface of transmissive material 101), a diffraction grating 112 (formed when a reflective coating 118 is applied as shown to the surface of transmissive material 101), a second mirror 114 (formed when a reflective coating 118 is applied as shown to the surface of transmissive material 101) and an exit surface 116.

The hyperspectral imaging system of the present disclosure operates to produce images of a remote object (not shown) over a contiguous range of narrow spectral bands when the slit 104 receives a beam 120 from the remote object and directs the beam 120 to the Offner spectrometer 102. Offner spectrometer 102 diffracts the beam 120 and forwards the diffracted beam 120′ to the detector 106. In particular, the slit 104 directs the beam 120 to the entrance surface 108. First mirror 110 receives the beam 120 transmitted through the entrance surface 108 and reflects the beam 120 towards the diffraction grating 112. The diffraction grating 122 receives the beam 120 and diffracts and reflects the diffracted beam 120′ to the second mirror 114. The second mirror 114 receives the diffracted beam 120′ and reflects the diffracted beam 120′ to the exit surface 116. The detector 106 processes the diffracted beam 120′ received from exit surface 116.

Transmissive material 101 is selected to have high transparency over the target range of wavelengths acquired from the scene during imaging. Wavelengths of interest may include near infrared wavelengths, visible wavelengths, and/or ultraviolet wavelengths. Materials suitable for transmissive material 101 include plastics, dielectrics, and gases. Representative materials include PMMA, polystyrene, polycarbonate, silicon, germanium, ZnS, ZnSe, CaF₂, air, nitrogen, argon, and helium. When a solid phase material is employed as transmissive material 101, the Offner spectrometer may be referred to herein as a monolithic Offner spectrometer. When a gas phase material is employed as transmissive material 101, the Offner spectrometer may be referred to herein as a reflective Offner spectrometer. In the reflective Offner spectrometer design, mirror 110, mirror 114, and grating 118 are affixed to chamber 107 through posts or other mounts. Use of a gas as the transmissive material facilitates the objective of minimizing the weight of the hyperspectral imaging system. Many gases also exhibit high transparency in the visible and near-infrared portions of the spectrum.

Detector 106 is selected to have a wavelength sensitivity based on the type of transmissive material 101 used to make the Offner spectrometer 102. For instance, if the the transmissive material of Offner spectrometer 102 were made from a plastic (e.g., polymethylmethacrylate (PMMA), polystyrene, polycarbonate) then the diffracted wavelength range would be primarily in the visible and the detector 106 may be a complementary metal-oxide-semiconductor (CMOS) video camera 106. If the transmissive material of monolithic Offner spectrometer 102 were made from an infrared transmitting material, then the detector 106 may be an IR detector, such as one based on mercury cadmium telluride (HgCdTe), indium antimonite (InSb) or lead sulphide (PbS).

The hyperspectral imaging system may further include additional optics to receive or direct beam 120 and/or diffracted beam 120′ to or from different directions to permit flexible positioning of slit 104 and/or detector 106 with respect to chamber 107.

The hyperspectral imaging system may include a data processor to process image data acquired from the scene. The image data may include spectral data, wavelength data, polarization data, intensity data, or positional data. The data processor may receive image data from the detection element and transform or otherwise manipulate image data into a form specified by the user. Data processing may include conversion of image data to any of several visual forms known in the art and may include coloring, shading, or other visual effects intended to represent position, depth, composition, or other features of objects in the scene. Data received and/or processed by the hyperspectral imaging system may be transferred to a display device for further processing and/or display. The display device may be integrated directly within the hyperspectral imaging system or may be at a remote position. The data transfer may occur through a data interface, such as a data link or USB connection. The hyperspectral imaging system may also include memory. The memory may be used to store image data. The image data may be unprocessed or processed image data. Image data stored in the hyperspectral imaging system may be downloaded to an external computer for processing. Image data stored in the hyperspectral imaging may be processed online or offline.

The hyperspectral imaging system may include a battery module. The battery module may include a rechargeable battery and may be removably coupled to the hyperspectral imaging system. Battery power may also be provided by a battery contained within the mobile display device. The hyperspectral imaging system may also be adapted to receive power from an external battery.

The hyperspectral imaging system is compact and lightweight. The hyperspectral imaging system may include a housing that contains the fore-optics module, the wavelength-dispersing module, and the detector. The size or shape of the housing may be determined by one or more linear dimensions, where a linear dimension is a length or distance in a straight-line direction. The linear dimensions may be oriented in three orthogonal directions (e.g. x-direction, y-direction, and z-direction in a Cartesian coordinate system) and may include a length, width, and height. The linear dimensions may include a diameter, or a length and diameter, or one or more edge or side lengths. The longest linear dimension of the housing may be 16 inches or less, or 15 inches or less, or 14 inches or less, or 13 inches or less, or 12 inches or less, or 11 inches or less or 10 inches or less, or 8 inches or less. The housing may be cylindrical in shape with a length of 14 inches or less and a diameter of 10 inches or less, or a length of 12 inches or less and a diameter of 8 inches or less, or a length of 12 inches or less and a diameter of 7 inches or less, or a length of 12 inches or less and a diameter of 6 inches or less, or a length of 11 inches or less and a diameter of 8 inches or less, or a length of 11 inches or less and a diameter of 7 inches or less, or a length of 11 inches or less and a diameter of 6 inches or less, or a length of 10 inches or less and a diameter of 7 inches or less, or a length of 10 inches or less and a diameter of 6 inches or less.

The fore-optics module may be configured as a forward-looking design or a downward-looking design. In a forward-looking design, the fore-optics module acquires image data in a direction aligned or substantially aligned with the direction of the longest linear dimension of the housing. In a downward-looking design, the fore-optics module acquires image data in a direction normal or substantially normal to the longest linear dimension of the housing. If the housing is cylindrical in shape with a length that exceeds the diameter, for example, the longest linear dimension of the housing is the length direction and a forward-looking fore-optics module is positioned to view images along the length direction of the housing (e.g. through an opening in the circular end of the cylinder). A downward-looking fore-optics module, in contrast, is positioned to view images along the radial direction of the housing (e.g. through an opening in the sidewall of the cylinder). A forward-looking fore-optics module may acquire image data from a direction parallel or substantially parallel to the ground. A downward-looking fore-optics module may acquire image data from a direction normal or substantially normal to the ground.

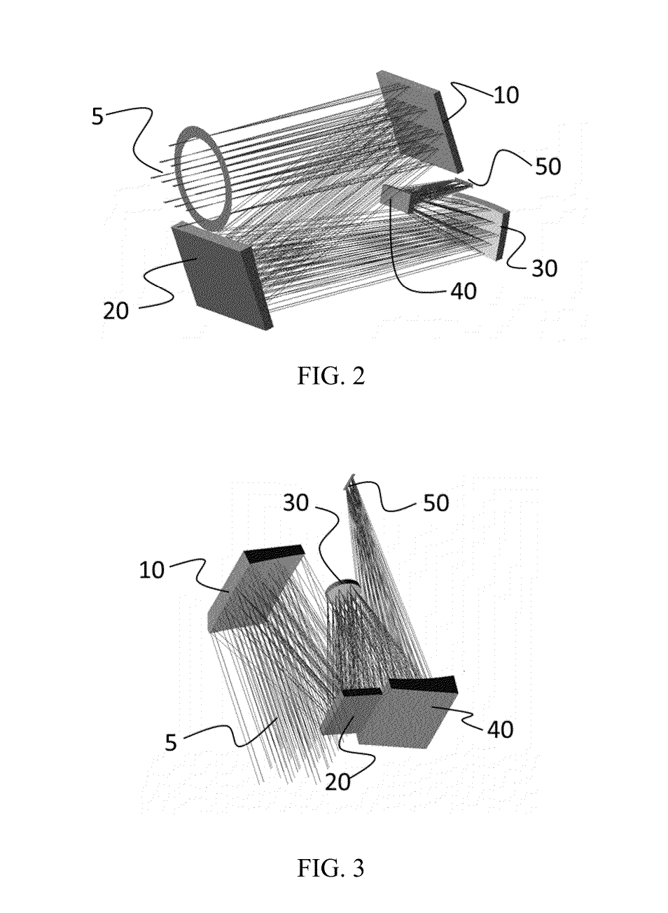

FIGS. 2 and 3 show different configurations of mirrors in a fore-optics module based on a four-mirror telescope. FIG. 2 depicts a forward-looking fore-optics module and FIG. 3 depicts a downward-looking fore-optics module. In both FIG. 2 and FIG. 3, the fore-optics module acquires image data in the form of electromagnetic rays 5 from a scene and directs them to mirror 10. Mirror 10 directs the image data to mirror 20, which directs the image data to mirror 30, which directs the image data to mirror 40, which delivers an output 50 that is directed to the entrance of the wavelength-dispersing module.

The hyperspectral imaging system may be lightweight. The combined weight of the housing, fore-optics module, and wavelength-dispersing module may be 4.0 kg or less, or 3.5 kg or less, or 3.0 kg or less, or 2.75 kg or less. The combined weight of the housing, fore-optics module, wavelength-dispersing module and detector may be 5.0 kg or less, or 4.5 kg or less, or 4.0 kg or less, or 3.75 kg or less. The hyperspectral imaging system may be a handheld system that permits image acquisition by hand scanning Image acquisition is also possible in pushbroom mode. The hyperspectral imaging system may include a mount for a pistol grip for handheld implementation. The hyperspectral imaging system may include a mount for placement on a tripod.

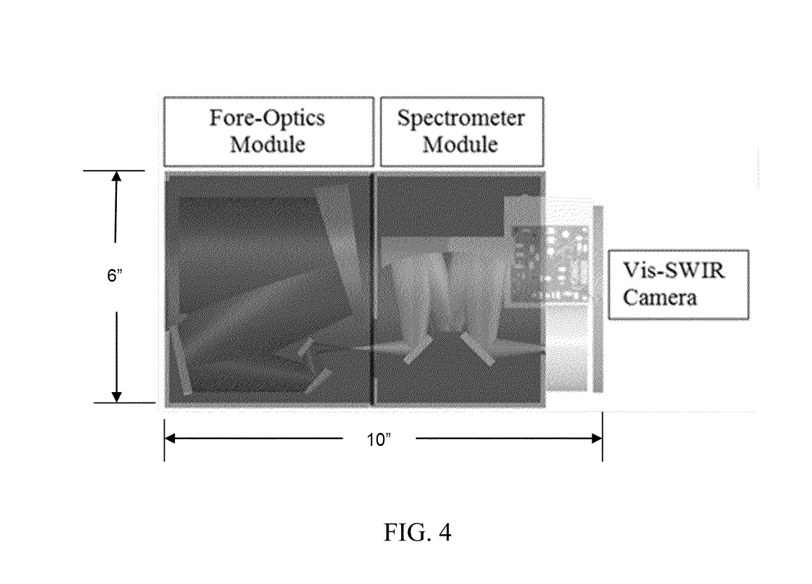

FIG. 4 depicts a hyperspectral imaging system that includes a forward-looking fore-optics module with a four-mirror telescope, a spectrometer module with an Offner spectrometer, and a detector (Vis-SWIR camera). The hyperspectral imaging system is incorporated in a cylindrical housing having a length of 10 inches and a diameter of 6 inches. The fore-optic module is operatively coupled to the spectrometer module along a common optical path. The detector is operatively coupled to the spectrometer along a common optical path.

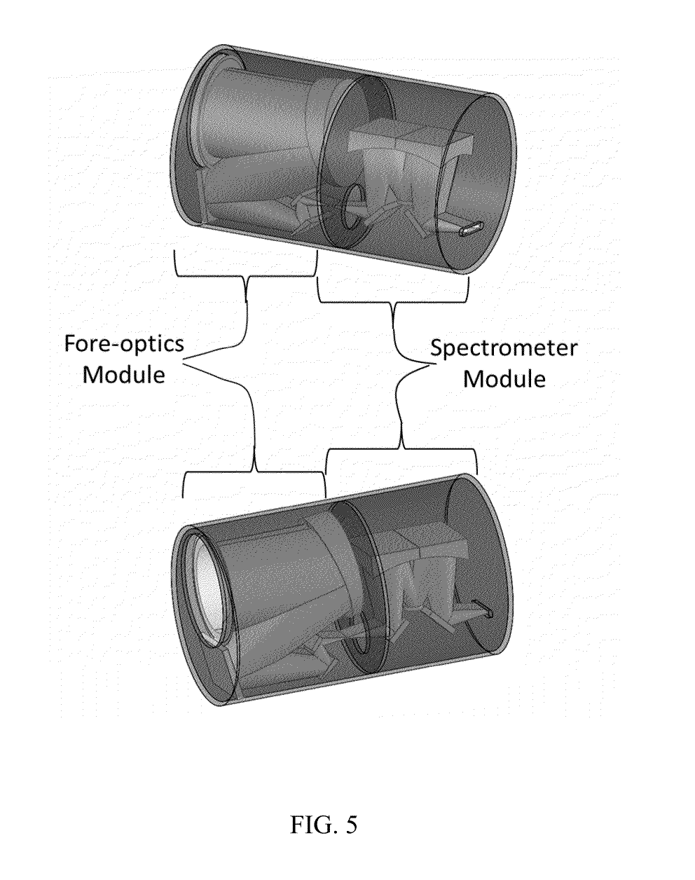

FIG. 5 shows two views of a hyperspectral imaging system with a housing that includes a forward-looking fore-optics module with a four-mirror telescope and a spectrometer module with an Offner spectrometer. The fore-optic module is operatively coupled to the spectrometer module along a common optical path.

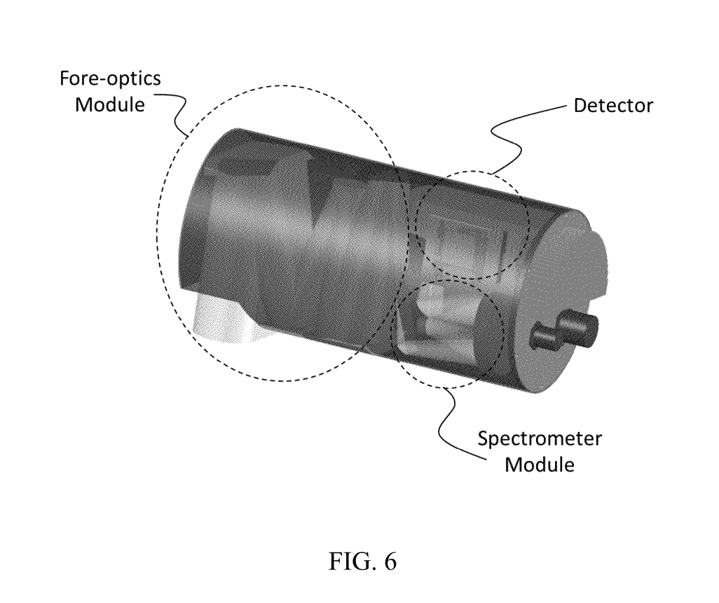

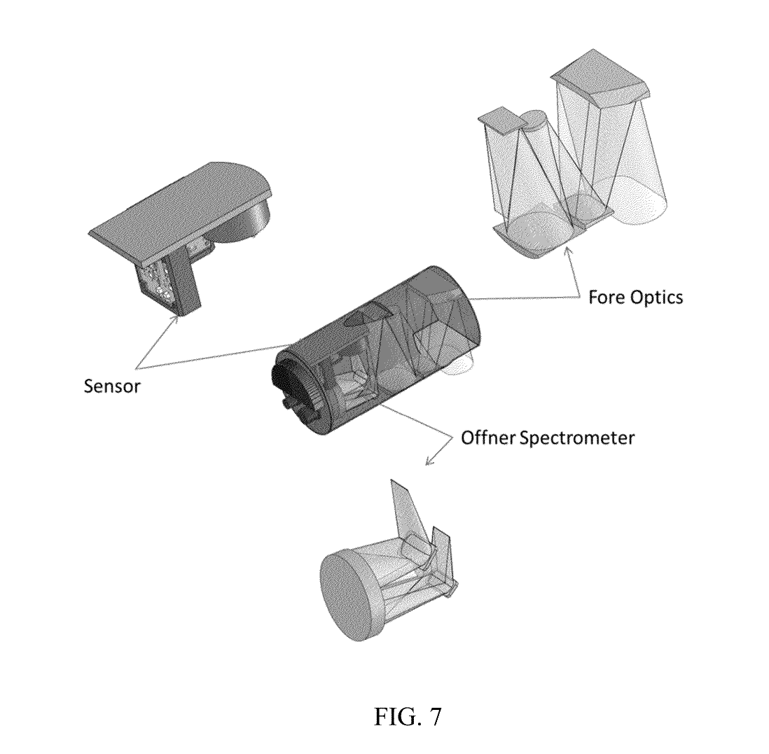

FIG. 6 shows a hyperspectral imaging system with a housing that includes a downward-looking fore-optics module with a four mirror telescope, a spectrometer module with an Offner spectrometer, and a detector. The housing is cylindrical in shape with a length of 10 inches and a diameter of 6 inches. The fore-optic module is operatively coupled to the spectrometer module along a common optical path. The detector is operatively coupled to the spectrometer along a common optical path. FIG. 7 is an exploded view of FIG. 6, in which the detector is labeled as a sensor.

The present disclosure further extends to methods of acquiring images. The methods including using the hyperspectral imaging system described herein to acquire an image. The image acquisition method may include selecting a scene and acquiring an image of the scene using a hyperspectral imaging system in accordance with the present disclosure.

The compact design and low weight of the present hyperspectral imaging system makes it suitable for hand scanning applications. The hyperspectral imaging system may be conveniently lifted and supported in one or both hands by the operator without a need for a tripod or other mounting system. The hyperspectral imaging system may be supported solely in the hand or hands of a user and may have no direct or indirect contact with the ground or other supporting medium. The method of the present disclosure may include providing a compact hyperspectral imaging system, supporting the hyperspectral imaging system in a hand of the operator, and acquiring an image while supporting the hyperspectral imaging system solely by hand. The image may be acquired through hand motion of the hyperspectral imaging system by the operator, or by ambulation of the operator.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A hyperspectral imaging system comprising:
a housing, said housing containing a fore-optics module, a wavelength-dispersing module, and a detector, said housing having a shape defined by one or more linear dimensions, the longest of said linear dimension being 16 inches or less.

2. The hyperspectral imaging system of claim 1, wherein the longest linear dimension of said housing is 12 inches or less.

3. The hyperspectral imaging system of claim 2, wherein said fore-optics module includes a telescope.

4. The hyperspectral imaging system of claim 3, wherein said telescope is telecentric.

5. The hyperspectral imaging system of claim 4, wherein said telescope includes three or more mirrors.

6. The hyperspectral imaging system of claim 5, wherein said mirrors include a silver coating, said silver coating enabling said mirrors to exhibit an average reflectivity of >87% in the wavelength range from 400 nm-425 nm, an average reflectivity of >93.5% in the wavelength range from 426 nm-450 nm, an average reflectivity of >98% in wavelength range from 451 nm-700 nm, and an average reflectivity of >98% in the wavelength range from 701 nm-2500 nm.

7. The hyperspectral imaging system of claim 3, wherein said telescope is downward looking

8. The hyperspectral imagining system of claim 2, wherein said wavelength-dispersing module includes a spectrometer.

9. The hyperspectral imagining system of claim 8, wherein said spectrometer is an Offner spectrometer.

10. The hyperspectral imaging system of claim 9, wherein said Offner spectrometer is a reflective Offner spectrometer.

11. The hyperspectral imaging system of claim 2, wherein said detector is a camera, a CCD, a sensor, a photodiode, or a focal plane array.

12. The hyperspectral imaging system of claim 2, wherein said system weighs 4 kg or less.

13. The hyperspectral imaging system of claim 4, wherein said telescope includes four or more mirrors, said wavelength-dispersing element includes an Offner spectrometer, and said housing has a cylindrical shape.

14. The hyperspectral imaging system of claim 13, wherein said cylindrical housing has a length of 11 inches or less and a diameter of 7 inches or less.

15. The hyperspectral imaging system of claim 14, wherein said system weighs 4 kg or less.

16. A method of acquiring an image comprising:
providing a hyperspectral imaging system, said hyper spectral imaging system having a size defined by one or more linear dimensions, the longest of said linear dimensions being 12 inches or less;
supporting portable hyperspectral imaging system, said supporting occurring solely by hand; and
acquiring an image with said hand-supported hyperspectral imaging system.
